(19) United States
(12) Patent Application Publication
(10) Pub. No.: US 2022/0019586 A1
(43) Pub. Date: Jan. 20, 2022

(54) PREDICTED PROPERTIES FOR DATABASE QUERY PLANNING

(71) Applicant: Pivotal Software, Inc., Palo Alto, CA (US)

(72) Inventor: Hao Wang, Beijing (CN)

(21) Appl. No.: 17/489,484

(22) Filed: Sep. 29, 2021

Related U.S. Application Data
(63) Continuation of application No. PCT/CN2019/080389, filed on Mar. 29, 2019.

(51) Int. Cl. G06F 16/2453

(52) U.S. Cl. CPC G06F 16/24542

(57) ABSTRACT

Methods, systems, and apparatus, including computer programs encoded on computer storage media, for using machine learned models to predict properties for database query planning. One of the methods includes receiving a query to be executed over one or more relations of a database. A query planner generates a candidate query plan comprising a plurality of operators to be executed to generate query results for the query. A predicted property of the portion of the query plan when executed on the database is computed for each of one or more portions of the query plan, including providing a respective representation of each portion of the query plan as input to a trained model configured to generate predicted properties of tuples generated by portions of query plans when executed on the database. A score for the candidate query plan is computed using the predicted property generated by the trained model.

### CROSS-REFERENCE TO RELATED APPLICATIONS

This application is a continuing application of, and claims priority under 35 U.S.C. § 120 to, PCT Application No. PCT/CN2019/080389, filed on Mar. 29, 2019. The disclosure of the foregoing application is incorporated here by reference.

### BACKGROUND

This specification relates to query planning for databases.

Databases store one or more tables. In this specification, a database table is a relation having one or more tuples, with each tuple having one or more elements that each correspond to a respective attribute of the relation. The tuples belonging to a database table can be stored in any appropriate form, and a relation being referred to as a database table does not imply that its tuples are stored contiguously or in tabular form. Distributed databases include tables that are partitioned across multiple storage devices, in which each partition stores a subset of rows or columns of a particular table.

Many databases use query planning in order to improve the efficiency of processing a query. When a database system receives a query, a query planner generates a number of candidate query plans that all compute a result for the query in different, but equally valid ways. The query planner computes an estimated cost for each candidate query plan in order to select a final query plan that will actually be used to compute a result for the query.

Accurate cost estimation by a query planner relies heavily on estimations of statistics of the underlying data that will be processed by a query. As one simple example, suppose a column of a database table stores 500,000 star ratings of movies, and that the star ratings have a minimum rating of 0.0 and a maximum rating of 5.0. For a query that specifies the predicate “star_rating>3.0,” the query planner can use the minimum and maximum to estimate that the query will return roughly 40% of all tuples in the table, or 200,000 tuples. This is likely to be a fairly close approximation, assuming a uniform distribution of values of the ratings.

However, such estimation techniques also produce significantly inaccurate estimations for some datasets. For example, suppose instead that the query predicate was “year=2017.” If using the same technique for the minimum and maximum, and assuming a range of 100 years, the query planner might estimate that 0.01 (or 1/100^{th}) of the rows are from 2017. But this estimate is likely to be far off because, due to ever-increasing movie production volume over time, as many as 5% of all movies ever made were made in 2017. Therefore, the estimate of movies year may be off by 500% or more. And it can get much worse than that. In this type of query, it is not uncommon to have a result that is off by 10,000%, e.g., when every row is from the same year but simple numerical estimation techniques guess that a single year is only 1% of the data.

Bad query estimation has a very detrimental effect on query performance, an effect that becomes more severe for database applications that require low-latency, e.g., online analytic processing applications.

### SUMMARY

This specification describes how a system can use historical data and machine learning to compute more accurate statistics for query planning. Instead of using simple numerical estimations, a system can use predicted statistics that are based on historical data representing query results that were actually produced by the system on previous queries. For example, suppose that on a previous query in the example movie database described in the background, the predicate was “year=2016” and, when that previous query was executed, 23,975 rows were returned. The system can use a trained machine learning model that uses such information as training data. Therefore, when the predicate “year=2017” is entered as input to the model, the model is likely to generate a value that is much closer to the actual answer, e.g., 24,500, instead of only 5,000 that would be returned from simple minimum and maximum estimation. Notably, the system need not have ever run a query for the year 2017. Rather, the fact that the features of 2017 are close to the features of 2016 in the training data is sufficient for the predictive model to generate a much higher quality estimation.

Particular embodiments of the subject matter described in this specification can be implemented so as to realize one or more of the following advantages. A query planner can use machine learning to compute more accurate query planning estimations than statistical methods. More accurate query planning estimations reduces the likelihood that a bad query plan is chosen, for example, due to inaccurate statistics or a complex predicate. Therefore, the computational efficiency of the system is improved overall.

In addition, the performance of the machine learning estimations tends to automatically get better over time as more training data is generated. This is in contrast to statistical methods, which require database administrators to frequently update statistics information about the tables of the database, which is a tedious and time-consuming process.

The machine-learned models can also take into account the query subplans for particular operators. This also helps to mitigate the propagation errors that can plague conventional statistical based methods. In other words, using the query subplans as input features helps to reduce the likelihood that one very bad estimation will propagate upward and spoil the entire query plan.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is a flowchart of an example process for scoring a candidate query plan.

FIG. 3A-B illustrate example query plans.

FIG. 4 is a flowchart to compute the predicted property of tuples based on if the confidence estimate satisfies a threshold.

FIGS. 5A-C illustrate example query plans.

Like reference numbers and designations in the various drawings indicate like elements.

### DETAILED DESCRIPTION

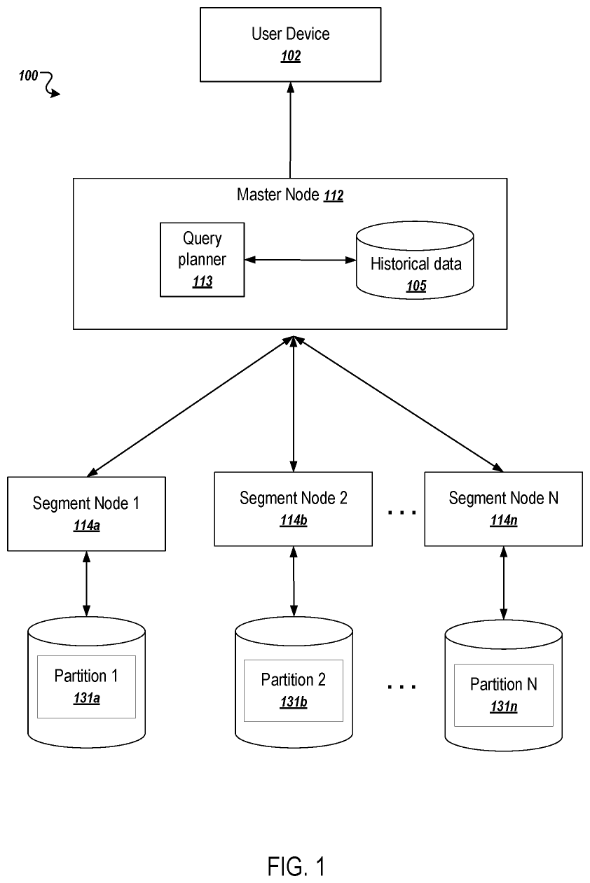

FIG. 1 is a diagram of an example system 100. The system 100 is an example of a computing system that can implement machine learning for query planning.

The distributed system 100 includes a master node 112 and multiple segment nodes 114a, 114b, through 114n. The master node 112 and each segment node 114a-n are implemented on one or more physical computers or as virtualization software components, e.g., a virtual machine or a container, installed on a physical computer. The master node 112 and the segment nodes 114a-n are connected by one or more communications networks, e.g., a local area network or the Internet. The master node 112 assigns each segment node to operate on a portion of data stored in the distributed system 100.

For example, the master node 112 can assign the segment node 114a to operate on a first partition 131 of a first database table. Similarly, the master node 112 can assign the segment node 114b to operate on a second partition 133 for the first database table, and the master node 112 can assign the segment node 114n to operate on a third partition 136 of a second database table.

A user of a user device 102 can access data stored in the distributed system 100 by communicating with the master node 112. The master node 112 can coordinate with the segment nodes 114a-114n to respond to requests for data from the user device 102. The user device 102 can issue a query, e.g., in structured query language (SQL) or object query language (OQL), to the master node 112.

The master node 112 can then communicate with the segment nodes 114a-114n to obtain data that satisfies the query. The master node 112 can divide the processing among N segment nodes, e.g., the segment nodes 114a-n. The segment nodes can access data in an underlying distributed storage system, for example, the Hadoop File System (HDFS).

When the master node 112 receives a query, the master node 112 uses a query planner 113 to generate a query plan. The query plan defines the operations that will be performed by the segment nodes to compute data satisfying the query. The query planner 113 can use the query and historical data 105 in order to compute predictions about the data in the partitions 131a-n that will be processed in order to compute a result for the query. In general, the historical data 105 includes data representing properties of nodes of previously executed query plans for the same database system. The properties can include query expressions corresponding to the node as well as statistics information about tuples that were generated from each query expression. In addition, the query planner 113 can access a system catalog that stores known or estimated statistics about the partitions 131a-n. Using this information, the query planner 113 can perform cost estimation and optimization algorithms to determine a query plan that reduces the overall cost, e.g., processing time and network bandwidth required, for computing a result for the query.

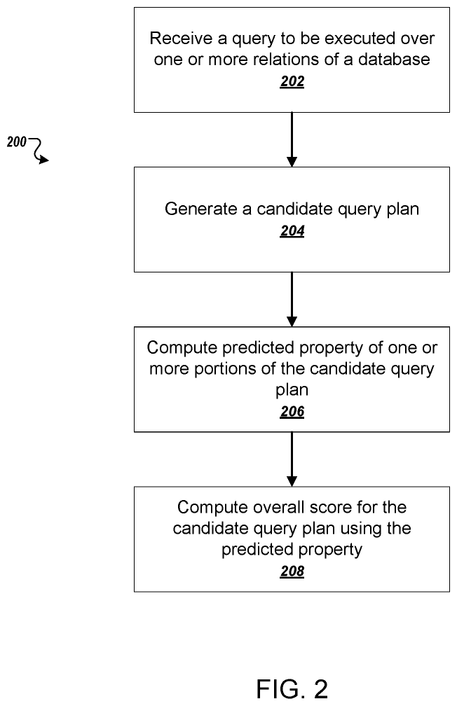

FIG. 2 is a flowchart of an example process for scoring a candidate query plan using predicted properties of portions of a query plan. For convenience, the process will be described as being performed by a system of one or more computers, located in one or more locations, and programmed appropriately in accordance with this specification. For example, a query planner of a database management system, e.g., the query planner 113 of FIG. 1, appropriately programmed, can perform the example process.

The system receives a query to be executed over one or more relations of a database (202) and generates a candidate query plan (204) in response. Each query plan specifies how to access data in the database and how various operators will be arranged to generate results that satisfy the query. Since the query planner can generate multiple equivalent candidate query plans, the query planner can analyze the different query plans to compute a score for each query plan, e.g., in order to determine which query plan is most likely to have the lowest computational cost.

Each query plan has a plurality of nodes, where each node represents a different respective operator to be used to generate results for the query. Types of operators included in the candidate query plan may be arithmetic, comparison, and logical operators, to name a few examples.

For example, the following query requests all entries from table_1 that exist in table_2 where the year was 2018:

```
select *
from table_1 inner join
  table_2
  on table_1.id = table_2.id
where date_part(‘year’, table_2.ctime) = 2018;
```

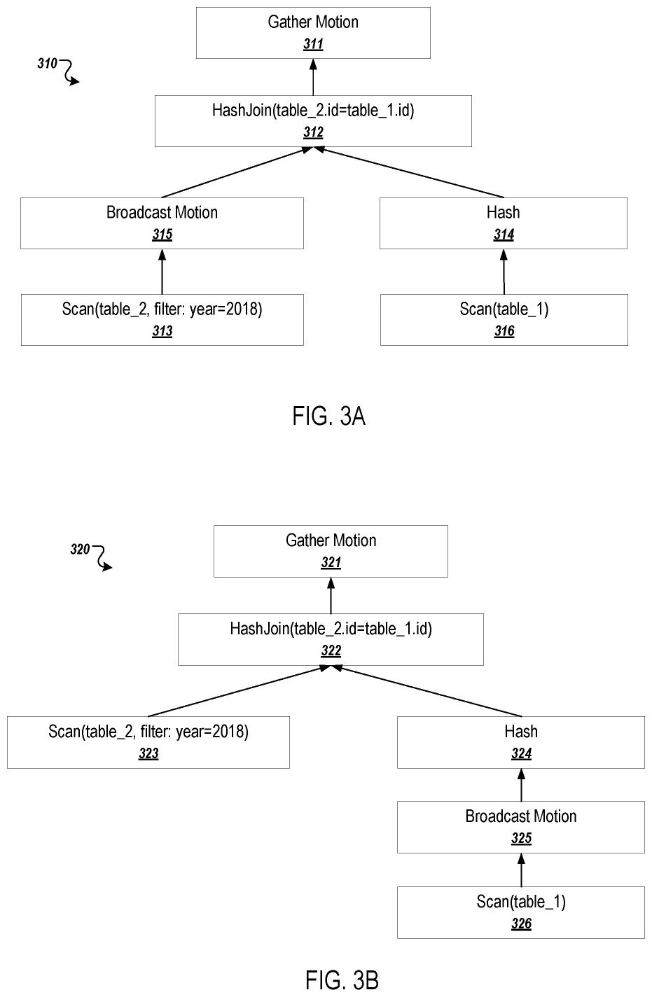

A number of different query plans can be used to compute query results for the example query. Two examples are illustrated in FIGS. 3A-B.

The main difference between the query plan in FIG. 3A and the query plan in FIG. 3B is the location of the Broadcast Motion operators 315 and 325. On a distributed database system, where some relations are partitioned across multiple segment nodes, some query operations require the movement of data between the nodes. In this particular query, the Hash Join operator requires all the matching tuples from either table_1 or from table_2 to be broadcast to all of the nodes. Each node can then perform a local Hash Join using its segment of the data for one table and the full set of broadcast matching tuples from the other table. Naturally, the ability to reasonably predict the size of data that is being transferred within the system is critical to selecting the best performing query plan.

As illustrated in FIG. 3A, the query plan 310 includes two Scan operators 313 and 316, a Broadcast Motion operator 315, a Hash operator 314, a Hash Join operator 312, and a Gather Motion operator 311. In operation, each segment node in a distributed database system can execute the query plan 310 by scanning table_1 and table_2 using the Scan operators 316 and 313 respectively. Each segment node can execute the Hash operator 314 that generates a hash value for each tuple returned by the scan of table_1.

Each segment node can execute the Broadcast Motion operator 315, which sends to every other segment node the results of the scan of table_2. After an indication that all applicable data has been received from every other segment node, each segment node can execute the HashJoin operator 312. The Gather Motion operator 311 then sends all the results to a same node, e.g., another segment node or the master node.

As illustrated in FIG. 3B, the query plan 320 includes two Scan operators 323 and 326, a Broadcast Motion operator 325, a Hash operator 324, a Hash Join operator 322, and a Gather Motion operator 321.

In comparison to the first query plan 310, the query plan 320 has its Broadcast Motion operator above the scan of table_1 instead of table_2. Intuitively, if the likely matching tuples of table_1 are vastly larger than those from table_2, then the system should choose the query plan 310 because doing so will likely result in less data transfer. If the opposite is true, the system should choose the query plan 320 for the same reasons. The following snippet is a textual representation of the first query plan 310 annotated with statistics-based cost estimates and row estimates for each operator.

TABLE 1

| Line | Text representation of first query plan 310 |
|---|---|
| 1 | Gather Motion 3:1 (slice2; segments: 3) (cost=1495.61...308361.77 rows=23 width=798) |
| 2 | −>Hash Join (cost=1495.61...308361.77 rows=8 width=798) |
| 3 | Hash Cond: table_2.id = table_1.id |
| 4 | −>Broadcast Motion 3:3 (slice1; segments: 3) (cost=0.00...306792.57 rows=9761 |
| 5 | width=402) |
| 6 | −>Seq Scan on table_2 (cost=0.00...306402.17 rows=3254 width=402) |
| 7 | Filter: date_part (‘year’::text, ctime) = 2018::double precision |
| 8 | −>Hash (cost=1218.05...1218.05 rows=7402 width=396) |
| 9 | −>Seq Scan on table_1 (cost=0.00...1218.05 rows=7402 width=396) |

As can be seen on line 6 of TABLE 1, according to the table statistics, table_2 is expected to return 3254 rows. On line 9, table_1 is expected to return 7402 rows. As a result, the query planner will choose the first query plan so that only 3254 tuples are broadcast among the segment nodes of the system by the Broadcast Motion operator. The following shows a textual representation of the second query plan 320 annotated with rows generated by a predictive model rather than pure statistics.

TABLE 2

| Line | Text representation second query plan 320 |
|---|---|
| 1 | Gather Motion 3:1 (slice2; segments: 3) (cost=2768.05...334528.82 rows=20492 width=798) |
| 2 | −>Hash Join (cost=2768.05...334528.82 rows=6831width=798) |
| 3 | Hash Cond: table_2.id = table_1.id |
| 4 | −>Seq Scan on table_2 (cost=0.00...306402.17 rows=3,333,334 width=402) |
| 5 | Filter: date_part (‘year’::text, ctime) = 2018::double precision |
| 6 | −>Hash (cost=2018.05...2018.05 rows=20000 width=396) |
| 7 | −>Broadcast Motion 3:3 (slice1; segments: 3) (cost=0.00...2018.05 rows=20000 |
| 8 | width=396) |
| 9 | −>Seq Scan on table_1 (cost=0.00...1218.05 rows=6,667 width=396) |

As can be seen on line 4 of TABLE 2, according to the predictive model, the Scan operator on table_2 is expected to return almost 3 million rows, while from line 9, the scan of table_1 is expected to return just 6667 rows. As a result, the query planner can choose the second query plan instead of the first query plan so that only 6,667 tuples are broadcast to all segment nodes of the system rather than 3 million tuples.

On this sample dataset, using the predictive model to generate the query plan resulted in a roughly 10× decrease in query processing time.

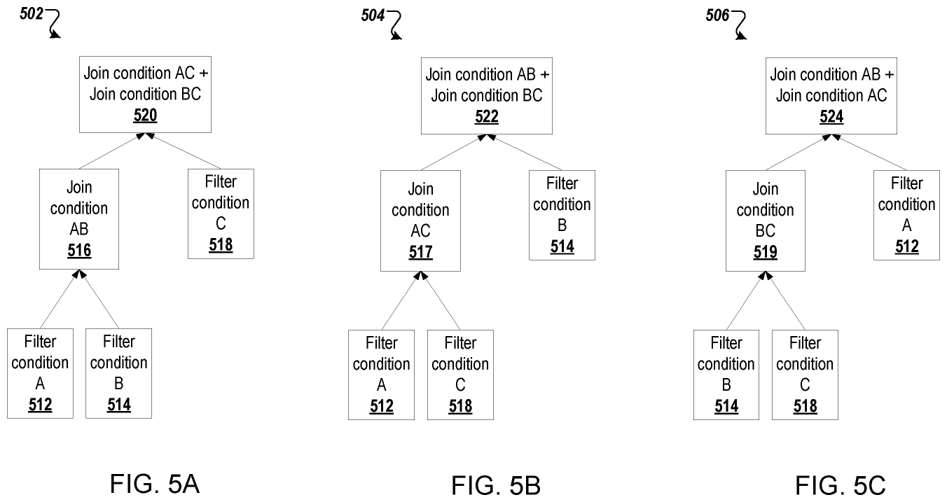

This example of selecting a location for the Broadcast Motion operator is most applicable to distributed databases that rely on network communications to compute query results. However, other query planning decisions are applicable to all databases. One such query planning decision is join order. The join order of a query plan specifies which joins are computed before other joins. A detailed example of using a predictive model to select join ordering is described below with reference to FIG. 5.

The system computes a predicted property of one or more portions of the query plan (206). The system can use any appropriate predictive model trained to generate a predicted property for a representation of a portion of the query plan.

The portion of the query plan can for example be a particular node or a subplan of the query plan. The system can for example generate a text representation of a node or a query subplan and use the text representation as input to the model.

As another example, the portion of the query plan can be a particular condition as well as one or more condition parameters. Common query conditions include join conditions and filter conditions. A join condition specifies one or more criteria for a join operator to return matching elements from different tables. A filter condition specifies one or more criteria for selecting tuples from a table or from an operator in the first instance. The system can use the text of the query itself as a representation of each condition. The system can also use other condition parameters as other inputs to the model, e.g., which tables are involved in the condition, a representation of the query subplan, or some combination of these.

The predicted property for a portion of a query is a value that that a query planner can use to compute a cost for a query plan. For example, the predicted property for a Scan operator on a table can be the number of rows predicted to be returned from the table for a particular query. As another example, for a Join operator, the predicted property can be the number of tuples expected to be processed or the number of tuples predicted to be joined. For a Broadcast operator, the predicted property can be a total number of tuples expected to be broadcast by the operator.

The predicted property can also represent the selectivity of a particular portion of a query plan. The selectivity of a portion of a query plan represents a fraction of tuples expected to be produced among all possible tuples. For example, if a select operator is expected to select only 10 out of 100 rows of a table, the predicted property can be expressed as a selectivity ratio of 0.10.

The predicted property can also represent a cost of computing resources to execute the node. For example, if a Broadcast motion operator will broadcast a large number of tuples, the models can generate costs to represent the network traffic and disk space required to support that operation.

To compute a predicted property for a portion of a query plan, the system can use a trained machine learning model for that portion of the query plan. The system can train a single machine learning model or multiple different models for different portions of a query plan. For example, the system can train one model for filter conditions and another model for join conditions.

As another example, the system can compute a different model for each of one or more operators or nodes of a query plan. Then, at query evaluation time, the system can obtain the models from an index of models. As one example, the models can be indexed by at least the operator type and one or more table identifiers. For example, if the node is a Scan operator for table_1, the system can obtain a machine learning model specially trained to predict the costs or rows resulting from Scan operators operating on table_1. In this scenario, the system can train a different model for the Scan operator for each of multiple different tables in the database. For example, if there are five tables in the database, the system can train five different models, one for each of the five tables. When an operator operates on multiple tables, e.g., the Join operator, the system can train a separate model for each combination of tables in the database. However, for systems in which this is computationally infeasible, the system can instead compute a single model for the Join operator using the table identifiers as input features.

In some other implementations, the system can train a separate model for different identifiable nodes in the query plan. Thus, for example, if a Scan operator of table_1 occurs in multiple places in the query plan, the system can train a different machine learning model for each node. In that case, the models can be separately indexed by a node identifier. This approach results in more specific models that generalize less well, but can be useful for systems that optimize the same or similar queries very frequently.

The input to the model generally includes a representation of the portion of the query to be predicted. For example, the input for a model trained for the Scan operator 323 shown in FIG. 3B can simply be the string “Scan(table_2, filter: year=2018)”, or some other appropriate representation. In some implementations, the models take as input a table identifier as a separate explicit input feature. Thus for example, the input to the model for the Scan operator can be a first text feature “year=2018,” and a second table identifier feature, table_1. As another example, for models trained for filter conditions and join conditions, the input features can be a text or tokenized representation of the filter condition or join condition, identifiers of tables involved in the filter condition or join condition, and optionally a separate representation of the subplan to which the condition applies.

The system can train the models using historical query plans that were executed over the same dataset. Each training example can include the features for a particular node and can be labeled with the actual value to be predicted, e.g., the actual selectivity fraction, a number of tuples produced, or another representation of cost, to name just a few examples. The system can use any appropriate machine learning model, e.g., text regression, linear regression, support vector machines, decision trees, or neural networks, to name just a few examples.

In some implementations, the system uses the historical query plans to train an ensemble of machine learning models to determine a candidate query plan's overall cost. The ensemble can contain any combination of machine learning models; the models could all be neural networks, or multiple linear regression models can be used in conjunction with a decision tree.

Each node in the historical query plan can be labeled with a number of properties resulting from executing the node on one or more tables. For example, the predicted property can represent the selectivity fraction, cardinality, cost of resources, time, or some combination of these, involved in executing the node. For example, the predicted property can be represented as a tuple having one or more variables, e.g., to represent the associated cost and cardinality.

The training system trains each model in the ensemble of one or more models to generate model outputs, i.e. the predicted property of a segment node, by processing model inputs, i.e. the segment node. In particular, the training system can train the machine learning model to determine trained values of the weights of the model from initial values of the weights. The initial values can be randomly initialized or generated through some other parameter initialization scheme. Various loss functions can be used to learn the trained weights of the model. The loss function can evaluate the accuracy of a single predicted property prediction. That is, when the loss function is used, the model is trained to generate a prediction for segment node input that minimizes the loss and thus most closely matches the ground truth. At each training step, the system can process a segment node input using the model to generate a predicted property for the input segment node. The system can then adjust the weights of the model according to deviations between the predicted property and the ground truth. This can be done by updating the weights to find the values of the weights of the model that minimize the chosen loss function.

Examples of features to be used by the machine learning models include statistics, table information, query conditions, the query plan path, cardinality, selectivity ranking, operator type, text of the operator, to name just a few examples. Features that are more important in determining model output accuracy can be assigned higher weights. The associated parameter of an operator may be considered a high value feature. For example, in the condition of “WHERE year=2018”, 2018 would be used as the parameter feature. Established feature engineering techniques such as feature combinations and extraction may be used to improve training.

The system computes an overall score for the candidate query plan (208). In general, the score can quantify the efficiency of executing the candidate query plan. The score can for example represent a total cost of executing the candidate query plan, either in terms of tuples produced, total selectivity, required computing resources, or some combination of these. For example, the predicted property of a portion of a query plan can for example represent a cardinality and cost to execute. The system can then sum the cost estimate of the predicted property for each portion of the query plan to generate a final cost estimate to execute the candidate query plan. Alternatively, the product, average, minimum, maximum etc. of the plurality of portions of the query plan can be used to compute the final cost.

The system can also rank the candidate query plan relative to one more other query plans according to their respective scores. The system can then select a highest-ranking query plan, or equivalently, the query with the lowest overall costs as a query plan to use for generating query results for the query. This process can allow the query planner to choose a join ordering among a plurality of different join orderings.

The system can also update the models after one or more query plans are executed. In other words, the system can compute scores for portions of the selected query plan and use the computed scores as training data labels to update the one or more machine learning models used to evaluate score the query plans. In other words, the system can continually update the models after each query, or each batch of queries, is executed to generate actual scores or costs for candidate query plans.

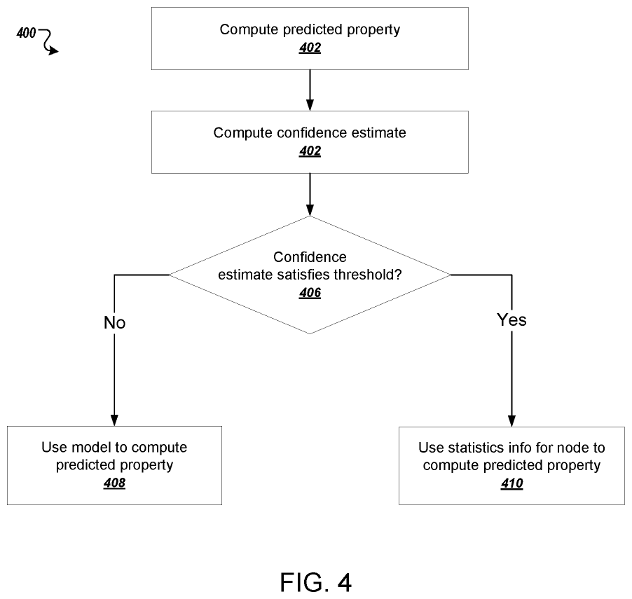

FIG. 4 is a flowchart of an example process for determining whether to use statistics or a machine learning model to generate a predicted property of tuples for a segment node. For convenience, the process will be described as being performed by a system of one or more computers, located in one or more locations, and programmed appropriately in accordance with this specification. For example, a master node of a database system, e.g., the master node 112 of FIG. 1, appropriately programmed, can perform the example process.

The system computes the predicted property of tuples for one or more nodes in a query plan (402).

The system computes a confidence estimate (404). The confidence estimate represents the likelihood of the predicted properties being accurate. The confidence estimates often reflect the amount of training data used to generate the models. For example, if the features of a particular query are encountered many times during training, the confidence estimate may be high. On the other hand, if the query is unique and has never been seen by the system before, the confidence estimate might be low. Heuristic standards can be used to derive the confidence estimates. Confidence estimates can be represented in any appropriate way, e.g., categories or percentages.

The system determines if the confidence estimate satisfies a threshold (406). The system can use a predefined system threshold on confidence in order to determine whether to use statistics or the machine learned model for the predicted property. If the predicted property of tuples of a node's confidence estimate does not meet the threshold, the system can use statistics to estimate the cost of that portion of the query plan (branch to 410). If the confidence estimates meets or exceeds the threshold, the system can use the predictive models to compute the predicted cost of the query plan (branch to 408).

Alternatively or in addition, the system can compute values for the predicted property using both a machine learned model and statistics estimate. The system can then choose to use the predicted property having a higher confidence estimate in order to score or select a query plan.

Another detailed example of using machine learning for query planning will now be described. The following database is assumed for the examples illustrated in FIGS. 5 and 6.

An example database has three tables: Table A, B and C. Each table has three columns. Table A has the following columns: Column A0, A1, A2 and A3; Table B has the following columns: Column B0, B1, B2 and B3; and Table C has the following columns: Column C0, C1, C2 and C3.

The tables have the following sizes:
1) Table A has 1,000 rows
2) Table B has 10,000 rows
3) Table C has 100,000 rows.

The system receives a query that requests three joins, each with a different join condition:
1) Table_A join Table_B with join condition Table_A.Column_A1=Table_B.Column_B1
2) Table_A join Table_C with join condition Table_A. Column_A2=Table_C.Column_C2
3) Table_B join Table_C with join condition Table_B.Column_B3=Table_C.Column_C3

As shorthand, these three join conditions may be referred to simply by their respective table names, e.g., join condition AB, join condition AC, and join condition BC.

The query also has the following three filter conditions:
1) Table_A.Column_A0>10
2) Table_B.Column_B0=2017
3) Table_C.Column_C0=“Susan”

As shorthand, these three filter conditions may be referred to simply by their respective table names, e.g., filter condition A, filter condition B, and filter condition C.

TABLE 3 contains a code snippet that is an example of how the join conditions and filter conditions of the query could be expressed in SQL:

TABLE 3

| | |
|---|---|
| 1 | SELECT * |
| 2 | FROM Table_A join Table_B on Table_A.Column_A1 = |
| 3 | Table_B.Column_B1 |
| 4 | join Table_C on Table_A.Column_A2 = Table_C.Column_C2 |
| 5 | and Table_B.Column_B3 = Table_C.Column_C3 |
| 6 | WHERE Table_A.Column_A0 > 10 AND Table_B.Column_B0 = |
| 7 | 2017 AND Table_C.Column_C0 = “Susan”; |

The join order of the example query is a major decision for the query planner. FIGS. 5A-C illustrate where the join conditions and filter conditions could be executed for three possible query plans. The three possible query plans illustrate different node placements for the three join conditions, e.g., the join condition AB 516, the join condition AC 517, and the join condition BC 519; three combination join conditions, e.g., join condition AC+join condition BC 520, join condition AB+join condition BC 522, and join condition AB+join condition AC 524; and the three filter conditions, e.g., the filter condition A 512, the filter condition B 514, and the filter condition C 518.

In order to choose a reasonably efficient query plan, the query planner may require reasonable estimates of the selectivity of each of the conditions in the candidate query plans.

For simplicity, ignoring the filter conditions for the moment, suppose that join condition AB 516 generates 10 million tuples but join condition AC 517 produces only 1 tuple. In that case, the first query plan 502 would generate at least 10,000,000×100,000=1 trillion tuples from joining the result of join condition AB with table C.

Meanwhile, the second query plan 504 would generate only 1×10,000=10,000 tuples from joining the result of join condition AC with Table B. Therefore, the second query plan 504 would require only 1/10,000th of the computing resources as the first query plan 502.

The selectivity of the filter conditions also greatly impacts the selectivity of the join conditions. For example, the filter condition A 512 may have a selectivity of 0.01, e.g. resulting in 10 rows, and filter condition B 514 may have a selectivity of 0.1, e.g., resulting in 1000 rows. In that case, the join condition AB 516 may have a selectivity of only 0.001, resulting in only 10 rows being produced.

Using statistics data alone can have significant shortcomings, for example, as described above where the data is not uniformly distributed by value. In addition, errors in the selectivity compound upwards in the query plan. For example, if the statistics-based selectivity of the filter condition A is incorrect, the query planner may propagate such errors upwards and compute a very inaccurate estimation of the join condition above it in the query plan. In addition, the selectivity may also be inaccurate for approximate values, e.g., if the filter condition C were “Name LIKE % an %.”

These problems can all be addressed by training a model that predicts the selectivity of each condition in the query plan. For example, the model can take as input the input conditions, the tables involved, and a representation of the subplan tree. Using the subplan tree can improve the prediction for complex conditions and reduces the effects of bad selectivity estimates propagating upwards in the query plan. In addition, the model can more accurately predict selectivity when the conditions specify only approximate values.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
receiving a query to be executed over one or more relations of a database;
generating, by a query planner of the database system, a candidate query plan comprising a plurality of operators to be executed to generate query results for the query;
computing, for each of one or more portions of the query plan, a predicted property of tuples generated by the portion of the query plan when executed on the database, including providing a respective representation of each portion of the query plan as input to a trained model that is configured to generate predicted properties of tuples generated by portions of query plans when executed on the database; and
computing a score for the candidate query plan using the predicted property generated by the trained model.

Embodiment 2 is the method of embodiment 1, wherein the candidate query plan comprises a plurality of nodes, each node representing a different respective operator to be executed to generate query results for the query, and
wherein providing a respective representation of each portion of the query plan as input to the trained model comprises providing a respective representation of one or more nodes of the query plan as input to the model.

Embodiment 3 is the method of any one of embodiments 1-2, wherein the predicted property computed for each portion of the query plan quantifies computing resources required to compute the portion of the query plan.

Embodiment 4 is the method of any one of embodiments 1-3, wherein the predicted property that is output by the trained model is a number of tuples expected to be generated by the portion of the query plan when executed on the database.

Embodiment 5 is the method of any one of embodiments 1-4, wherein the predicted property output by the trained model is a measure of selectivity of the portion of the query plan when executed on the database.

Embodiment 6 is the method of any one of embodiments 1-5, wherein the operations comprise:
obtaining a plurality of historical query plans executed on the database system, and, for each historical query plan, one or more properties of one or more portions of the historical query plan; and
using the portions of the plurality of historical query plans as training data to train one or more models, wherein each model uses a representation of a portion of the query plan as input and generates a predicted property as output.

Embodiment 7 is the method of any one of embodiments 1-6, wherein the operations comprise:
ranking the candidate query plan relative to one or more other query plans according to the score that is based on the predicted property generated by the trained model.

Embodiment 8 is the method of embodiment 7, wherein a particular query plan of the one or more other query plans was generated using only statistics information.

Embodiment 9 is the method of any one of embodiments 1-8, wherein computing a predicted property of tuples generated by the portion of the query plan comprises:
determining a confidence estimate in statistics information for the portion of the query plan;
determining that the confidence estimate does not satisfy a threshold; and
in response, using the trained model to compute the predicted property instead of using the statistics information for the portion of the query plan.

Embodiment 10 is the method of any one of embodiments 1-9, wherein each portion of the query plan represents a different query condition of the query.

Embodiment 11 is the method of any one of embodiments 1-10, wherein the trained model is trained on filter conditions, join conditions, or both.

Embodiment 12 is the method of any one of embodiments 1-11, wherein the trained model takes as an input feature a representation of a query subplan of the portion of the query.

Embodiment 13 is a system comprising: one or more computers and one or more storage devices storing instructions that are operable, when executed by the one or more computers, to cause the one or more computers to perform the method of any one of embodiments 1 to 12.

Embodiment 14 is a computer storage medium encoded with a computer program, the program comprising instructions that are operable, when executed by data processing apparatus, to cause the data processing apparatus to perform the method of any one of embodiments 1 to 12.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A database system comprising:
one or more computers and one or more storage devices storing instructions that are operable, when executed by the one or more computers, to cause the one or more computers to perform operations comprising:
receiving a query to be executed over one or more relations of a database;
generating, by a query planner of the database system, a candidate query plan comprising a plurality of operators to be executed to generate query results for the query;
computing, for each of one or more portions of the query plan, a predicted property of tuples generated by the portion of the query plan when executed on the database, including providing a respective representation of each portion of the query plan as input to a trained model that is configured to generate predicted properties of tuples generated by portions of query plans when executed on the database; and
computing a score for the candidate query plan using the predicted property generated by the trained model.

2. The system of claim 1, wherein the candidate query plan comprises a plurality of nodes, each node representing a different respective operator to be executed to generate query results for the query, and
wherein providing a respective representation of each portion of the query plan as input to the trained model comprises providing a respective representation of one or more nodes of the query plan as input to the model.

3. The system of claim 1, wherein the predicted property computed for each portion of the query plan quantifies computing resources required to compute the portion of the query plan.

4. The system of claim 1, wherein the predicted property that is output by the trained model is a number of tuples expected to be generated by the portion of the query plan when executed on the database.

5. The system of claim 1, wherein the operations comprise:
obtaining a plurality of historical query plans executed on the database system, and, for each historical query plan, one or more properties of one or more portions of the historical query plan; and
using the portions of the plurality of historical query plans as training data to train one or more models, wherein each model uses a representation of a portion of the query plan as input and generates a predicted property as output.

6. The system of claim 1, wherein the operations comprise:
ranking the candidate query plan relative to one or more other query plans according to the score that is based on the predicted property generated by the trained model.

7. The system of claim 1, wherein computing a predicted property of tuples generated by the portion of the query plan comprises:
determining a confidence estimate in statistics information for the portion of the query plan;
determining that the confidence estimate does not satisfy a threshold; and
in response, using the trained model to compute the predicted property instead of using the statistics information for the portion of the query plan.

8. A computer-implemented method comprising:
receiving a query to be executed over one or more relations of a database;
generating, by a query planner of the database system, a candidate query plan comprising a plurality of operators to be executed to generate query results for the query;
computing, for each of one or more portions of the query plan, a predicted property of tuples generated by the portion of the query plan when executed on the database, including providing a respective representation of each portion of the query plan as input to a trained model that is configured to generate predicted properties of tuples generated by portions of query plans when executed on the database; and
computing a score for the candidate query plan using the predicted property generated by the trained model.

9. The method of claim 8, wherein the candidate query plan comprises a plurality of nodes, each node representing a different respective operator to be executed to generate query results for the query, and
wherein providing a respective representation of each portion of the query plan as input to the trained model comprises providing a respective representation of one or more nodes of the query plan as input to the model.

10. The method of claim 8, wherein the predicted property computed for each portion of the query plan quantifies computing resources required to compute the portion of the query plan.

11. The method of claim 8, wherein the predicted property that is output by the trained model is a number of tuples expected to be generated by the portion of the query plan when executed on the database.

12. The method of claim 8, further comprising:
obtaining a plurality of historical query plans executed on the database system, and, for each historical query plan, one or more properties of one or more portions of the historical query plan; and
using the portions of the plurality of historical query plans as training data to train one or more models, wherein each model uses a representation of a portion of the query plan as input and generates a predicted property as output.

13. The method of claim 8, further comprising:
ranking the candidate query plan relative to one or more other query plans according to the score that is based on the predicted property generated by the trained model.

14. The method of claim 8, wherein computing a predicted property of tuples generated by the portion of the query plan comprises:
determining a confidence estimate in statistics information for the portion of the query plan;
determining that the confidence estimate does not satisfy a threshold; and
in response, using the trained model to compute the predicted property instead of using the statistics information for the portion of the query plan.

15. One or more non-transitory computer storage media encoded with a computer program, the program comprising instructions that are operable, when executed by data processing apparatus, to cause the data processing apparatus to perform operations comprising:
receiving a query to be executed over one or more relations of a database;
generating, by a query planner of the database system, a candidate query plan comprising a plurality of operators to be executed to generate query results for the query;
computing, for each of one or more portions of the query plan, a predicted property of tuples generated by the portion of the query plan when executed on the database, including providing a respective representation of each portion of the query plan as input to a trained model that is configured to generate predicted properties of tuples generated by portions of query plans when executed on the database; and
computing a score for the candidate query plan using the predicted property generated by the trained model.

16. The computer storage media of claim 15, wherein the candidate query plan comprises a plurality of nodes, each node representing a different respective operator to be executed to generate query results for the query, and
wherein providing a respective representation of each portion of the query plan as input to the t rained model comprises providing a respective representation of one or more nodes of the query plan as input to the model.

17. The computer storage media of claim 15, wherein the predicted property computed for each portion of the query plan quantifies computing resources required to compute the portion of the query plan.

18. The computer storage media of claim 15, wherein the predicted property that is output by the trained model is a number of tuples expected to be generated by the portion of the query plan when executed on the database.

19. The computer storage media of claim 15, the operations further comprising:
obtaining a plurality of historical query plans executed on the database system, and, for each historical query plan, one or more properties of one or more portions of the historical query plan; and
using the portions of the plurality of historical query plans as training data to train one or more models, wherein each model uses a representation of a portion of the query plan as input and generates a predicted property as output.

20. The computer storage media of claim 15, wherein computing a predicted property of tuples generated by the portion of the query plan comprises:
determining a confidence estimate in statistics information for the portion of the query plan;
determining that the confidence estimate does not satisfy a threshold; and
in response, using the trained model to compute the predicted property instead of using the statistics information for the portion of the query plan.
